(19) United States
(12) Patent Application Publication
(10) Pub. No.: US 2026/0264208 A1
(43) Pub. Date: Sep. 10, 2026

(54) Multipurpose Hammer

(71) Applicant: Charles E. Holloway, II, Denver, CO (US)

(72) Inventor: Charles E. Holloway, II, Denver, CO (US)

(21) Appl. No.: 19/557,915

(22) Filed: Mar. 5, 2026

Related U.S. Application Data
(60) Provisional application No. 63/767,412, filed on Mar. 5, 2025.

(51) Int. Cl. B25F 1/00; G01B 3/04; G01C 9/02; G01C 15/00

(52) U.S. Cl. CPC B25F 1/006; G01B 3/04; G01C 9/02; G01C 15/004

(57) ABSTRACT

A multipurpose hammer comprising numerous tools built into the hammer. The hammer encompasses a standard hammer, ruler, a pry bar, a nail remover and a leveler. The level is positioned within the handle of the handle of the hammer and the hammer has ruler etchings, both inches and centimeters, on the handle for ease of use. The base of the hammer has a tapered panel to serve as a pry bar. Further, the hammer head has a laser built into the surface of the head. The hammer has a standard hammering face and also a nail remover.

### FIELD OF THE INVENTION

The present invention relates generally to a multipurpose hammer. More specifically, the present invention is a device that provides the user with all the necessary components to perform tasks in one device.

### BACKGROUND OF THE INVENTION

Hammers and rulers are essential tools found in many toolboxes and workshops, each serving distinct yet crucial purposes. Hammers, typically consisting of a heavy head attached to a handle, are used for driving nails, pounding surfaces, and general construction tasks. They come in various types, including claw hammers for pulling nails and ball-peen hammers for metalwork. Rulers, on the other hand, are precision measuring instruments used to gauge length, width, and distance. They provide accurate measurements and are commonly made of metal, plastic, or wood, featuring markings in inches, centimeters, or both. While hammers are indispensable for tasks requiring force and impact, rulers are indispensable for precise measurement and layout work. Together, they form a fundamental toolkit for woodworking, carpentry, construction, and various DIY projects, ensuring accuracy and efficiency in tasks requiring both strength and precision.

An objective of the present invention is to provide users with a multipurpose hammer, that can measure, pry, and check the level of surfaces. The present invention intends to provide users with a device that offers comfortability, ease of use, and easy access to each tool. In order to accomplish that, a preferred embodiment of the present invention comprises a hammer handle, a hammer head, and a pry bar. Further, the hammer head can drive nails or remove nails from a surface. Thus, the present invention is a multipurpose hammer that provides the user with a multitude of tools for performing various tasks when fixing or creating structures.

### SUMMARY OF THE INVENTION

The present invention is a multipurpose hammer that can accomplish various needs at any time. The present invention seeks to provide users with a device that can drive nails, pry nails, measure surfaces, check the level of surfaces, and pry objects. In order to accomplish this the present invention comprises a hammer handle which allows the user to measure and check the level of various surfaces. Further, the hammer head drives and removes nails from the surface of an object. Additionally, the pry bar can remove objects from a surface or separate objects from each other. Thus, the present invention is a multipurpose hammer that provides the user with a multitude of tools for performing various tasks when fixing or creating structures.

### BRIEF DESCRIPTION OF THE DRAWINGS

FIG. 1 is a top front right perspective view of the present invention.

FIG. 2 is a bottom rear left perspective view of the present invention.

FIG. 3 is a front view of the present invention.

FIG. 4 is a rear view of the present invention.

FIG. 5 is a right-side view of the present invention.

FIG. 6 is a left-side view of the present invention.

FIG. 7 is a top view of the present invention.

FIG. 8 is a bottom view of the present invention.

### DETAIL DESCRIPTIONS OF THE INVENTION

All illustrations of the drawings are for the purpose of describing selected versions of the present invention and are not intended to limit the scope of the present invention.

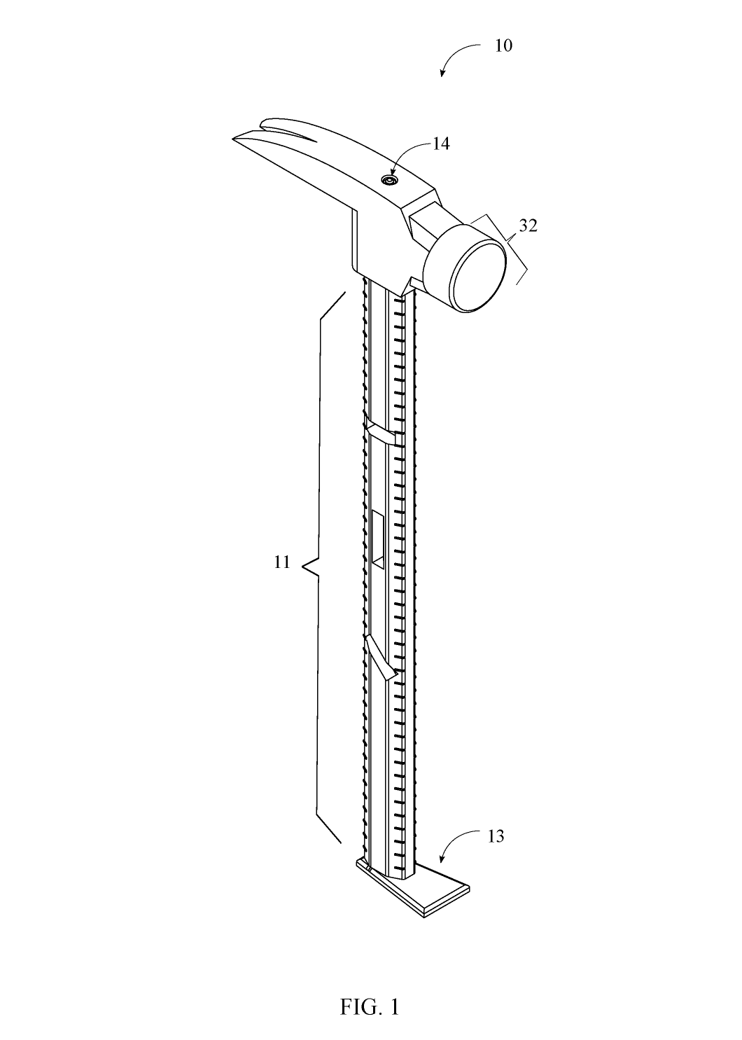

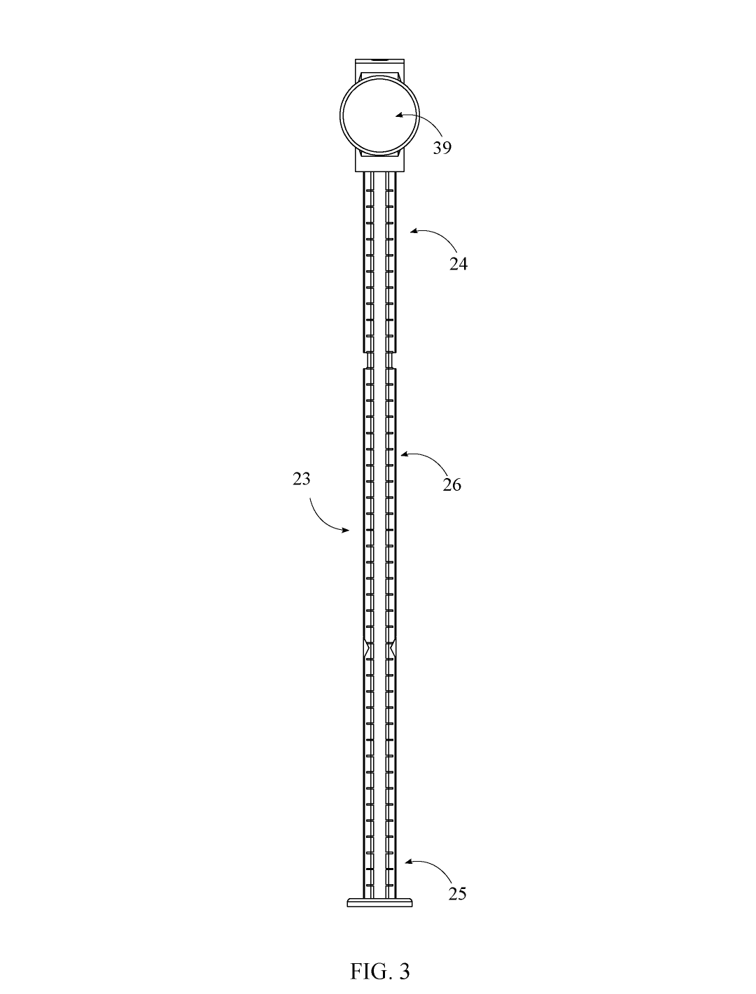

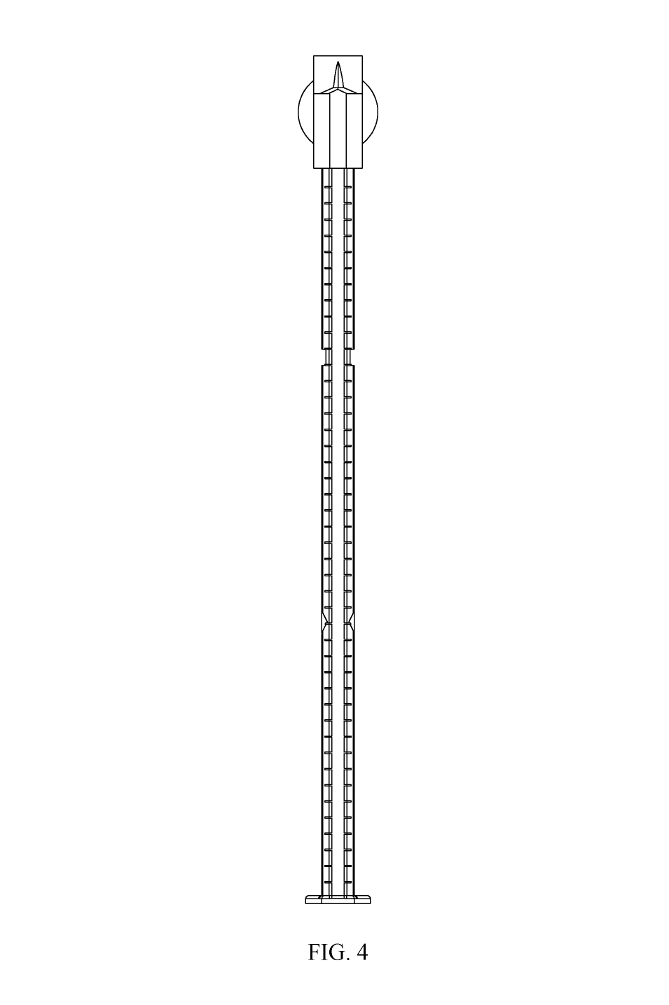

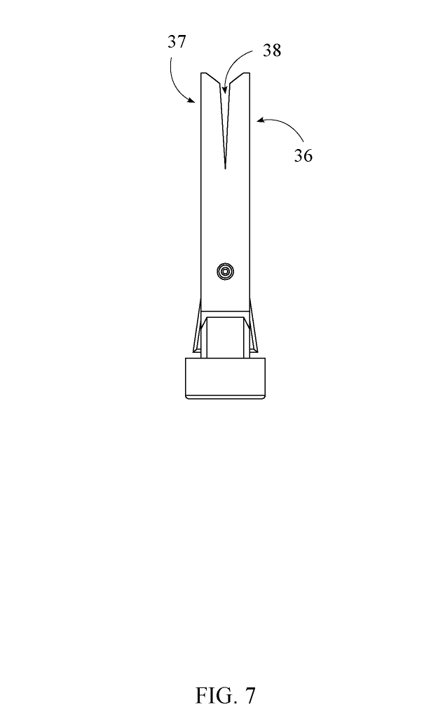

As shown in FIG. 1-8, the present invention is a multipurpose hammer 10 that can be utilized in a variety of situations. An objective of the present invention is to provide users with a leveling tool that can indicate whether a surface is horizontal or vertical. The present invention intends to provide users with a device that can remove nails from a surface or force apart two objects. To accomplish this the present invention comprises a handle 11, a hammer head 12, and a pry bar 13. Many of these components allow for the user to utilize multiple tools within one device. The hammer head 12 is positioned along the top terminal end of the hammer handle 11. The pry bar 13 is positioned on the bottom distal end of the shaft 23 and extends outwards towards the front of the present invention. Thus, the present invention is a multipurpose hammer that provides the user with a multitude of tools for performing various tasks when fixing or creating structures.

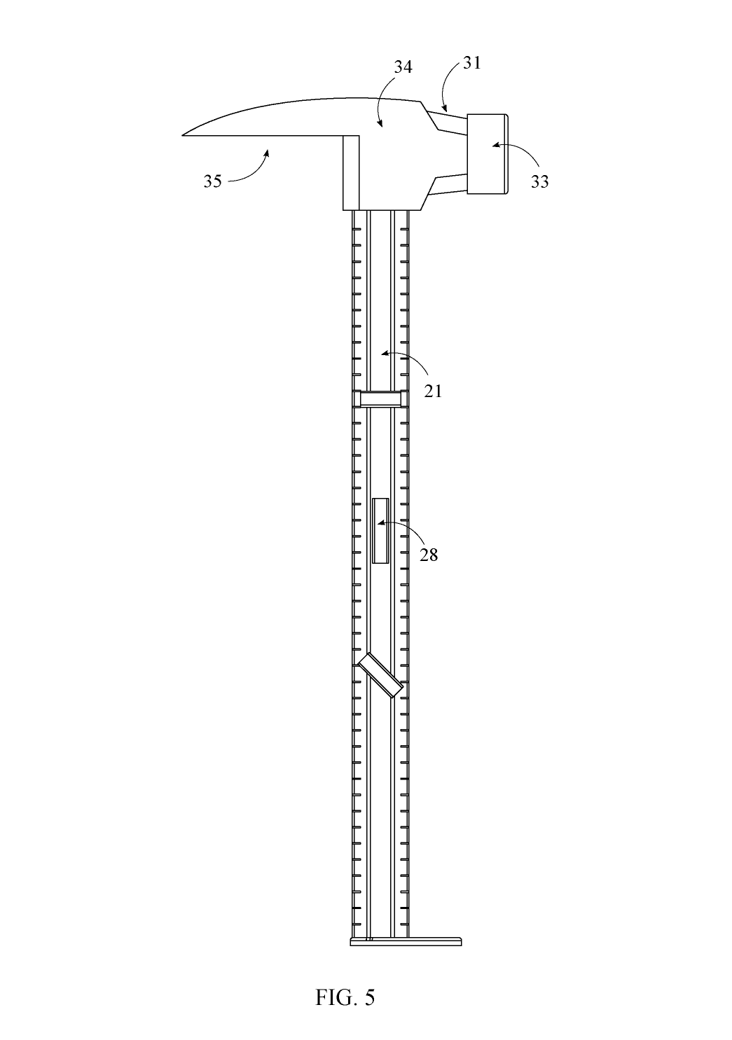

The present invention provides a handle 11 comprising a shaft 23, a proximal end 24, a distal end 25, and a central grasp 26. The central grasp 26 where the user can grip the present invention with the hammer handle 11. The central grasp 26 being positioned between the proximal end 24 and the distal end 25. The shaft 23 is designed with a long rectangular shape and a strong material that provides structural strength as seen in FIG. 5.

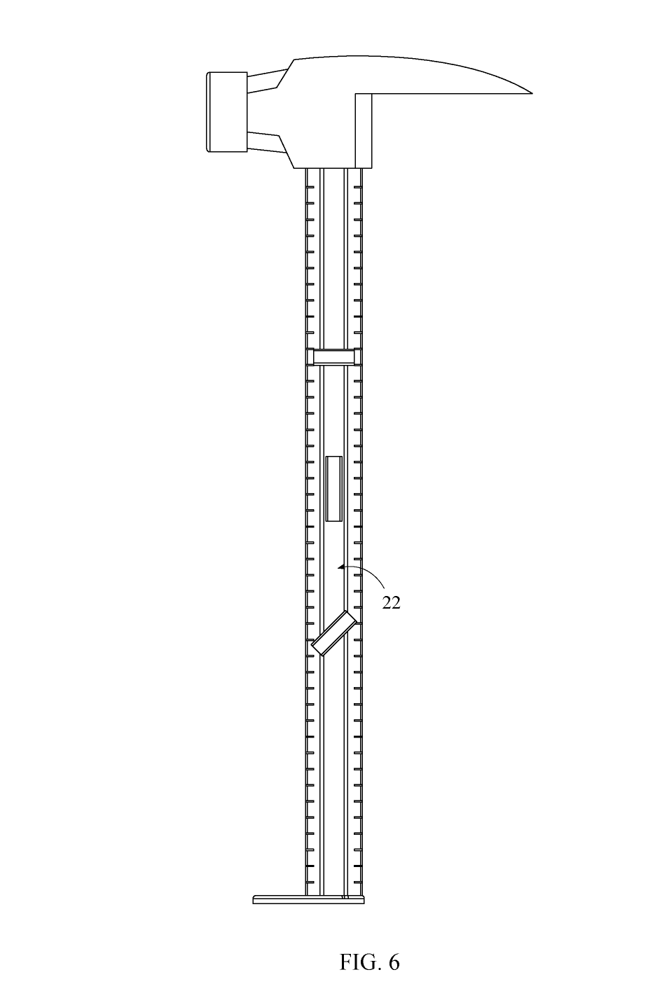

In its preferred embodiment the handle 11 comprises at least one ruler 27 and at least one level 28. The at least one level 28 is positioned about the shaft 23. At least one ruler 27 is positioned along either the front side 21 or the rear side 22 of the shaft 23 as shown in FIG. 1. The at least one ruler 27 is evenly spaced out notches the protrude from the surface of the hammer handle 11. The at least one ruler 27 comprises an inches ruler and a centimeters ruler. The at least one ruler 27 traverses the length of the shaft 23. The inches ruler 27 measures and spaces each notch out based on inches while the centimeters ruler 27 measures and spaces each notch out based on centimeters. The at least one level 28 is positioned near the center of the shaft 23 and is integrated within the shaft 23. The at least one level 28 is a rectangular cutout through the hammer handle 11 within a clear cylindrical structure positioned within the length of the rectangular cutout. The at least one level 28 could comprises a vertical level, a horizontal level, or a 45-degree level. The vertical level 28 is positioned centrally within the hammer handle 11 with the rectangular cutout positioned vertically. The horizontal level is positioned above the vertical level within the hammer handle 11 with the rectangular cutout positioned horizontally. The 45-degree level 28 is positioned below the vertical level 28 within the hammer handle 11 with the rectangular cutout positioned at a 45-degree angle as shown in FIG. 6. It should be further noted that, the hammer handle 11 can be created in many various shapes and sizes and the at least one ruler 27s and at least one level 28 could be positioned in various ways while staying within the scope of the present invention.

The hammer head 12 is positioned along the top side of proximal end of the shaft 23. The hammer head 12 is designed with a metal material that can drive nails without becoming structurally damaged. The hammer head 12 is designed with a short cylindrical shape positioned horizontally along the front side of the hammer head 12. This area is where the hammer head 12 contacts an external nail for driving a nail into a surface. The hammer head 12 comprises a nail remover, a neck 31 and an intermedial unit 34. The intermedial unit 34 is a solid metal core that supports the neck 31 and the nail removed of the hammer head 12. The intermediate unit 34 comprises an upper surface, in which a laser 14 is positioned about. The laser 14 is positioned and integrated within the hammer head 12. The laser 14 is designed to project outwards along the top of the hammer head 12 to be utilized to ensure a level 28 indicator for precise measuring.

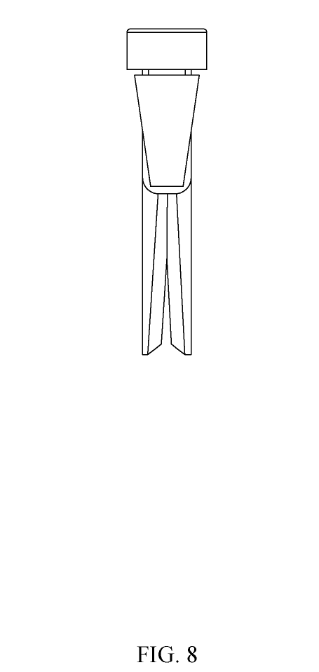

Along the rear side of the hammer head 12 is the nail lever. The nail lever is a curved structure with a V-shaped notch that engages with the head 12 of an external nail as shown in FIG. 8. The anil remover comprises a first arm 36 and a second arm 37. The first arm 36 and the second arm 37 extend slightly apart from one another forming a central split 38 positioned between the first arm 36 and the second arm 37. The central split 38 is necessary as a nail is positioned in the central split 38 and the tension of the multipurpose hammer against the nail will remove it form the surface it is nailed into.\

The neck 31 extends from the intermedial unit 34, opposite the nail remover. The multipurpose hammer comprises a face 32. The face 32 is connected to the neck, opposite the intermedial unit 34. The face 32 is formed by a hammering surface 39 and a poll 33. The poll 33 is parametrically positioned around the hammering surface 39.

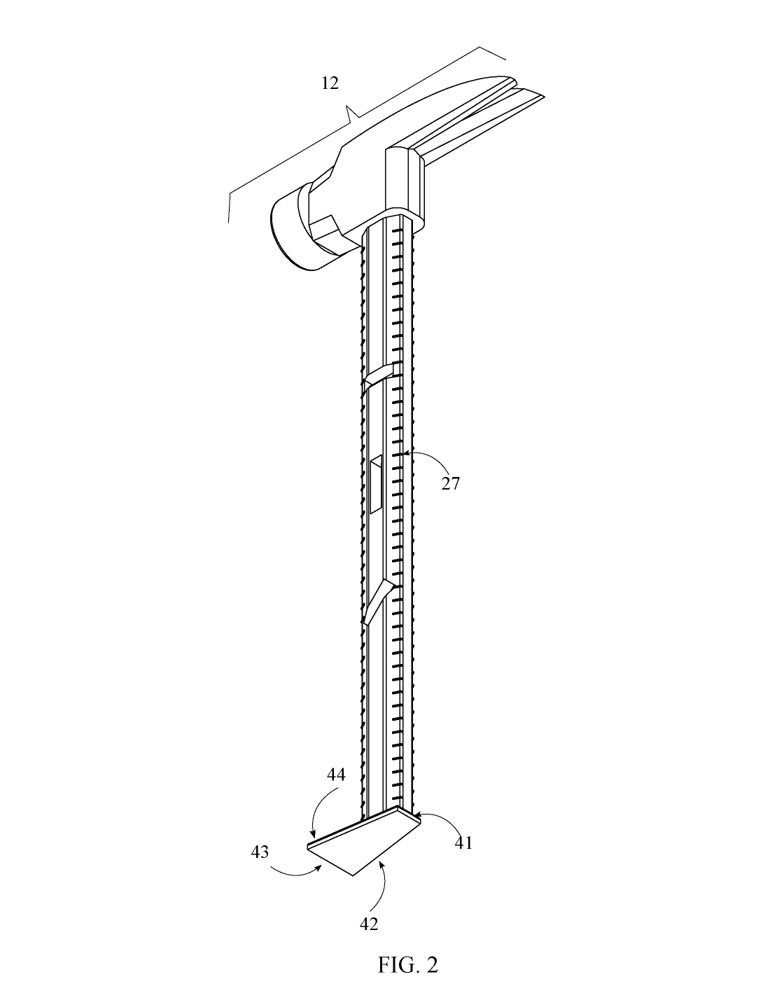

The pry bar 13 comprises a first end and a second end. The pry bar 13 is positioned about the distal end of the hammer handle 11 opposite the hammer head 12 as shown in FIG. 2. The pry bar 13 is designed with a metal material. The pry bar 13 is defined by a first edge 41, a second edge 42, a third edge 43, and a fourth edge 44. The first edge 41 and the third edge 43 are parallel to one another while the second edge 42 and the fourth edge 44 having different slopes forming a trapezoid shape. The first edge 41 is positioned between the second edge 42 and fourth edge 44. The third edge 43 being positioned between the fourth edge 44 and second edge 42, opposite the first edge 41. The pry bar 13 is wider at one end. The pry bar 13 extends outwards towards the front of the present invention. The longer side of the trapezoid on the pry bar 13 is positioned towards the front end of the present invention. The pry bar 13 is designed to pry two objects apart from each other. With all the components working in tandem with each other it can be seen that the present invention is a multipurpose hammer that provides the user with a multitude of tools for performing various tasks when fixing or creating structures.

Although the invention has been explained in relation to its preferred embodiment, it is to be understood that many other possible modifications and variations can be made without departing from the spirit and scope of the invention.

What is claimed is:

1. A multipurpose hammer comprising:
a handle;
a head;
the head comprising a laser;
the handle comprising a shaft;
the shaft comprising a distal end, a proximal end, and a central grasp; and
the head being positioned about the proximal end of the shaft.

2. The multipurpose hammer of claim 1 further comprising:
a pry panel;
the pry panel having a first end a second end; and
the pry panel being positioned about the distal end of the shaft.

3. The multipurpose hammer of claim 2 further comprising:
the pry panel being defined by a first edge, a second edge, a third edge, and a fourth edge;
the first edge and the third edge being parallel to one another;
the second edge and the fourth edge having different slopes from one another; and
the first edge being positioned between the second and fourth edge.

4. The multipurpose hammer of claim 3 further comprising:
the third being positioned between the first and second edge, opposite the first edge; and
the pry panel being wider at one end.

5. The multipurpose hammer of claim 1 further comprising:
the shaft comprising a front side and a rear side;
at least one ruler;
the at least one ruler being positioned about the front side of the shaft; and
the at least one ruler traversing the length of the front side.

6. The multipurpose hammer of claim 1 further comprising:
the head comprising a nail remover, a neck, and an intermedial unit;
the intermedial unit having an upper surface;
the laser being positioned about the upper surface; and
the nail remover extending from intermedial unit.

7. The multipurpose hammer of claim 6 further comprising:
The nail remover comprising a first arm and a second arm; and
A central split being positioned between the first arm and the second arm.

8. The multipurpose hammer of claim 1 further comprising:
The neck extending from the intermedial unit opposite the nail remover.
The face comprising a hammering surface and a poll;
The poll being perimetrically positioned around the hammering surface;
The poll being positioned between the hammering surface and the neck.

9. The multipurpose hammer of claim 1 further comprising:
At least one level; and
The at least one level being positioned about the central grasp.

10. A multipurpose hammer comprising:
a handle;
a head;
the head comprising a laser;
the handle comprising a shaft;
the shaft comprising a distal end, a proximal end, and a central grasp;
the head being positioned about the proximal end of the shaft; and
a pry panel.

11. The multipurpose hammer of claim 10 further comprising:
the pry panel having a first end a second end;
the pry panel being positioned about the distal end of the shaft;
the pry panel being defined by a first edge, a second edge, a third edge, and a fourth edge;
the first edge and the third edge being parallel to one another; and
the second edge and the fourth edge having different slopes from one another.

12. The multipurpose hammer of claim 11 further comprising:
the first edge being positioned between the second and fourth edge;
the third being positioned between the first and second edge, opposite the first edge; and
the pry panel being wider at one end.

13. The multipurpose hammer of claim 10 further comprising:
the shaft comprising a front side and a rear side;
at least one ruler;
the at least one ruler being positioned about the rear side of the shaft; and
the at least one ruler traversing the length of the rear side.

14. An multipurpose hammer of claim 10 further comprising
the head comprising a nail remover, a neck, and an intermedial unit;
the intermedial unit having an upper surface; and
the laser being positioned about the upper surface.

15. The multipurpose hammer of claim 14, wherein the cutter assembly further comprises:
the nail remover extending from intermedial unit;
the nail remover comprising a first arm and a second arm; and
A central split being positioned between the first arm and the second arm.

16. The multipurpose hammer of claim 13, wherein the plurality of cutter gears further comprises:
the neck extending from the intermedial unit opposite the nail remover.
the face comprising a hammering surface and a poll;
the poll being perimetrically positioned around the hammering surface;
the poll being positioned between the hammering surface and the neck;
at least one level;
the at least one level being positioned about the central grasp.

17. The multipurpose hammer comprising:
a handle;
a head;
the head comprising a laser;
the handle comprising a shaft;
the shaft comprising a distal end, a proximal end, and a central grasp;
the head being positioned about the proximal end of the shaft;
a pry panel;
the pry panel having a first end a second end;
the pry panel being positioned about the distal end of the shaft;
the pry panel being defined by a first edge, a second edge, a third edge, and a fourth edge;
the first edge and the third edge being parallel to one another; and
the second edge and the fourth edge having different slopes from one another.

18. The multipurpose hammer of claim 17, wherein the plurality of first gears further comprises:
the first edge being positioned between the second and fourth edge;
the third being positioned between the first and second edge, opposite the first edge;
the pry panel being wider at one end;
the shaft comprising a front side and a rear side;
at least one ruler;
the at least one ruler being positioned about the rear side of the shaft; and
the at least one ruler traversing the length of the rear side.

19. The multipurpose hammer of claim 17, wherein the second motor assembly further comprises:
the head comprising a nail remover, a neck, and an intermedial unit;
the intermedial unit having an upper surface; and
the laser being positioned about the upper surface;
the nail remover extending from intermedial unit;
the nail remover comprising a first arm and a second arm; and
A central split being positioned between the first arm and the second arm;
the neck extending from the intermedial unit opposite the nail remover.
the face comprising a hammering surface and a poll;
the poll being perimetrically positioned around the hammering surface;
the poll being positioned between the hammering surface and the neck;
at least one level; and
the at least one level being positioned about the central grasp.
